(19) United States
(12) Patent Application Publication
(10) Pub. No.: US 2026/0252262 A1
(43) Pub. Date: Aug. 27, 2026

(54) ELECTRONIC DEVICE AND METHOD WITH PROCESSING-IN-MEMORY

(71) Applicants: Samsung Electronics Co., Ltd., Suwon-si (KR); Seoul National University R&DB Foundation, Seoul (KR)

(72) Inventors: Jung Ho AHN, Seoul (KR); Jongmin KIM, Seoul (KR); Sungmin YUN, Seoul (KR); Hyesung JI, Seoul (KR); Wonseok CHOI, Seoul (KR); Sangpyo KIM, Seoul (KR)

(73) Assignees: Samsung Electronics Co., Ltd., Suwon-si (KR); Seoul National University R&DB Foundation, Seoul (KR)

(21) Appl. No.: 19/446,242

(22) Filed: Jan. 12, 2026

(30) Foreign Application Priority Data
Feb. 27, 2025 (KR) 10-2025-0026131

(51) Int. Cl. G06F 3/06

(52) U.S. Cl. CPC G06F 3/0655; G06F 3/061; G06F 3/0679

(57) ABSTRACT

A memory device includes one or more memory banks, and one or more operators disposed to access the one or more memory banks and configured to perform an operation on polynomial data, wherein, in response to the polynomial data being distributed to the one or more memory banks, the one or more operators are configured to perform parallel operations on the polynomial data, and in response to controlling data input/output between the one or more memory banks and the one or more operators, the one or more operators are configured to perform a modular operation and the one or more memory banks are configured to store a result of the modular operation.

### CROSS-REFERENCE TO RELATED APPLICATIONS

This application claims the benefit under 35 USC § 119(a) of Korean Patent Application No. 10-2025-0026131 filed on Feb. 27, 2025 in the Korean Intellectual Property Office, the entire disclosure of which is incorporated herein by reference for all purposes.

### BACKGROUND

### 1. Field

The following description relates to an electronic device and method with processing-in-memory (PIM).

### 2. Description of Related Art

A memory device is a component for data storage and retrieval and may be used in a computer system, a server, a mobile device, and an embedded system. Typically, the memory device may be classified into dynamic random access memory (DRAM), static RAM (SRAM), or flash memory, and each type may be configured to suit a specific application field depending on the performance, power consumption, and non-volatility.

Processing-in-memory (PIM) technology may reduce data movement cost and improve computational performance. The PIM technology may be configured to perform an operation while minimizing data movement by including a computational function in a memory or an area near the memory. The PIM technology may be integrated with high-speed memory, such as high bandwidth memory (HBM), graphics double data rate (GDDR), or non-volatile memory (NVM). However, a typical memory architecture may not effectively perform a PIM operation while maintaining the typical DRAM structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a memory device includes one or more memory banks, and one or more operators disposed to access the one or more memory banks and configured to perform an operation on polynomial data, wherein, in response to the polynomial data being distributed to the one or more memory banks, the one or more operators may be configured to perform parallel operations on the polynomial data, and in response to controlling data input/output between the one or more memory banks and the one or more operators, the one or more operators may be configured to perform a modular operation and the one or more memory banks may be configured to store a result of the modular operation.

The one or more memory banks may be divided into a plurality of channels or groups, and polynomial coefficients of the polynomial data may be distributed to a corresponding channel or group.

Pieces of the polynomial data for different modular operations may be distributed to different memory dies.

One or more polygroups may be generated by mapping polynomial coefficients of the polynomial data into a two-dimensional (2D) structure in each of the one or more memory banks.

For the performing of the modular operation, the one or more operators may be configured to perform the modular operation on the polynomial data by accessing the one or more polygroups sequentially or in parallel.

A determined range of a polynomial coefficient may be distributed to each row group by designating one or more memory cells in the memory bank to a plurality of row groups.

A determined range of a polynomial coefficient may be distributed to each column group by designating one or more memory cells in the memory bank to a plurality of column groups.

The one or more operators may include a parallel operation path for performing any one or any combination of any two or more of modular addition, modular multiplication, and constant multiplication operations on a polynomial coefficient in parallel, and the one or more operators may be configured to perform the any one or any combination of any two or more of the modular addition, the modular multiplication, and the constant multiplication operations in one or more operation cycles.

The one or more operators may include a buffer for storing an intermediate result, and the one or more operators may be configured to store used data in the buffer and reuse the used data.

The one or more operators may be configured to perform an operation corresponding to a bit-width of a polynomial coefficient of the polynomial data, and perform the modular operation by using modulus information.

The one or more operators may be configured to process a compound operation through a plurality of modular multiplication operations and a plurality of modular addition operations, and control a positive operation, a negative operation, and a constant multiplication operation during a process of the compound operation.

The one or more memory banks may be configured to independently perform activation and precharge operations, and while one of the one or more memory banks performs activation, another one of the one or more memory banks may be configured to read or write data from or to a preactivated row.

In one or more general aspects, an electronic device includes one or more host processors, and the memory device, wherein a polynomial operation command and the polynomial data are received by the one or more memory devices from the one or more host processors and are provided to the one or more operators.

In one or more general aspects, a method of operating a memory device includes dividing and distributing polynomial data to one or more memory banks, performing a parallel operation by one or more operators disposed to access the one or more memory banks, performing a modular operation by controlling data input/output between the one or more memory banks and the one or more operators, and storing a result of the modular operation in the one or more memory banks.

The dividing and distributing of the polynomial data to one or more memory banks may include dividing the one or more memory banks into a plurality of channels or groups, and distributing the polynomial data to distribute polynomial coefficients of the polynomial data to the divided channels or groups.

The dividing and distributing of the polynomial data to one or more memory banks may include distributing polynomial data for different modular operations to different memory dies to distinguish the polynomial data by modulus.

The dividing and distributing of the polynomial data to one or more memory banks further may include generating one or more polygroups by mapping polynomial coefficients of the polynomial data into a two-dimensional (2D) structure in each of the one or more memory banks.

The performing of the modular operation may include performing the modular operation by accessing the one or more polygroups sequentially or in parallel.

The generating of the one or more polygroups may include designating one or more memory cells in the memory bank to a plurality of row groups, and distributing a determined range of a polynomial coefficient of the polynomial data to each of the row groups.

In one or more general aspects, an electronic device includes one or more host processors, and one or more memory devices, each comprising one or more memory banks, and one or more operators disposed to access the one or more memory banks and configured to perform an operation on polynomial data, wherein a polynomial operation command and polynomial data received by the one or more memory devices from the one or more host processors are provided to the one or more operators, the polynomial data is divided into channels or groups and the divided polynomial data is distributed to the one or more memory banks, a modular operation is performed by the one or more operators by reading the polynomial data from the one or more memory banks, and a result of the modular operation is stored in the one or more memory banks.

Other features and aspects will be apparent from the following detailed description, the drawings, and the claims.

### BRIEF DESCRIPTION OF THE DRAWINGS

FIG. 1 is a block diagram schematically illustrating a memory device according to one or more embodiments.

FIG. 2 is an example of an instruction set architecture (ISA) of a polynomial computing device in a memory device, according to one or more embodiments.

FIG. 3 is a schematic diagram of a column partitioning data layout according to one or more embodiments.

FIG. 4 is a diagram of an operation performing algorithm of PAccum, according to one or more embodiments.

FIG. 5 is a schematic diagram of custom-logic processing-in-memory (PIM) according to one or more embodiments.

FIG. 6 is a schematic flowchart of an operating method of a memory device, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of the relevant art and specifically in the context of the present disclosure, and are not to be construed as an ideal or excessively formal meaning unless expressly so defined herein.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

The one or more embodiments may be implemented as various types of products, such as, for example, a personal computer (PC), a laptop computer, a tablet computer, a smartphone, a television (TV), a smart home appliance, an intelligent vehicle, a kiosk, and a wearable device. Hereinafter, embodiments will be described in detail with reference to the accompanying drawings. When describing the one or more embodiments with reference to the accompanying drawings, like reference numerals refer to like elements and a repeated description related thereto will be omitted.

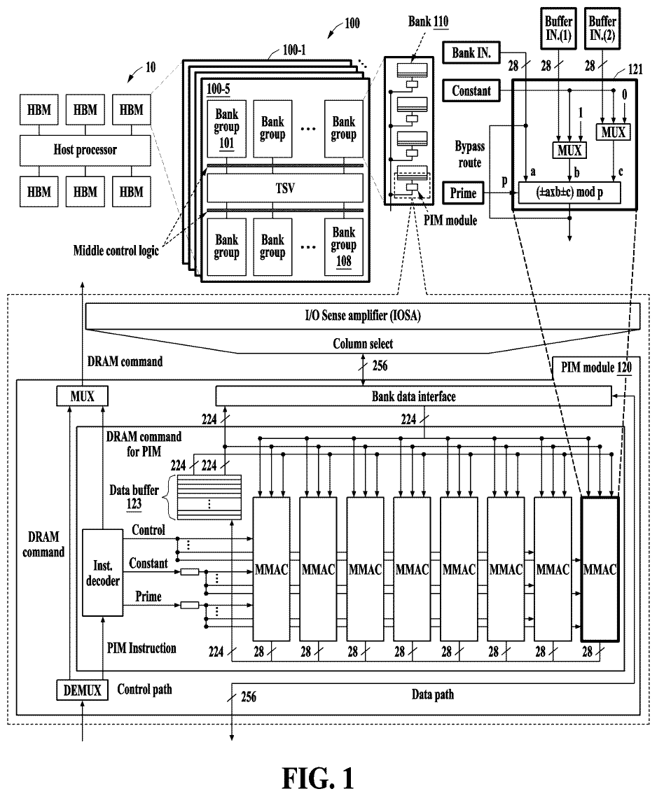

FIG. 1 is a block diagram schematically illustrating a memory device according to one or more embodiments.

One or more blocks of FIG. 1 or a combination thereof may be implemented by a special-purpose hardware-based computer configured to perform a specific function, and/or by a combination of computer instructions and special-purpose hardware.

An electronic device 10 in one or more embodiments may include a host processor (e.g., one or more host processors) and one or more memory devices 100. The one or more memory devices 100 may include one or more memory banks and one or more operators disposed to access the one or more memory banks and configured to perform an operation on polynomial data, respectively.

According to one or more embodiments, the electronic device 10 may provide, to the one or more operators, polynomial data and a polynomial operation instruction received from the host processor. The electronic device 10 may distribute the polynomial data to the one or more memory banks channel or group-wise. The electronic device 10 may perform a modular operation in the one or more operators by reading the polynomial data from the one or more memory banks and may store a modular operation result in the one or more memory banks.

The memory device 100 according to one or more embodiments may be hardware that supports processing-in-memory (PIM) for element-wise operations, such as addition, subtraction, multiplication, constant multiplication, and a combination thereof.

The PIM may indicate a hardware structure configured to perform an operation in the memory or near the memory. The PIM may be a scheme to improve the computational performance while minimizing data movement.

The PIM may be implemented in various manners depending on the type of memory to be applied. A PIM structure may be based on static random access memory (SRAM), dynamic RAM (DRAM), flash memory, and resistive RAM (ReRAM). The following examples describe DRAM-based PIM technology as a representative example. However, the example is not limited thereto and may be applied to various memories described above.

The DRAM-based PIM may be divided into various schemes depending on the complexity of computational functions. Some PIMs may support only simple data copy (e.g., a copy operation) or a bit-wise operation. This scheme may be implemented without changing the existing DRAM architecture and may operate by using a memory controller and/or a portion of circuitry in the DRAM.

The DRAM-based PIM that supports a more complex operation may include hardware configured to directly perform an arithmetic operation, such as a numerical operation including addition and multiplication. This may significantly improve the computational performance while reducing input/output overhead of data and may be used for an application field, such as artificial intelligence (AI), machine learning (ML), signal processing, and a cryptographic operation.

The data arrangement and access schemes may be important factors in efficiently using the PIM. DRAM may store and access data in rows and columns, and may sequentially read or write multiple columns after activating a specific row. To efficiently implement the PIM, an operation target, such as a polynomial coefficient or matrix data, may be disposed in the memory in an appropriate manner, and data flow between the operator and the memory may be optimized.

Additionally, the hardware that performs the PIM operation may be divided into a case in which the hardware is disposed in the memory (near-bank PIM) or a case in which the hardware is implemented at a memory module level (near-memory PIM). In the near-bank PIM, a computational module may be disposed in a DRAM bank 110 or an adjacent area, and this may reduce a data movement cost. In the near-memory PIM, an operation may be performed by using a buffer chip in a DRAM module or an additional processing unit.

The DRAM-based PIM technology may be used in various fields, such as deep learning acceleration, database processing, a cryptographic operation, and image processing. For example, maximizing the memory bandwidth and computational speed may be an important issue in high-performance computing (HPC) and data center environments, and PIM may be used as a solution to this issue.

There may be several factors to consider in configuring the DRAM-based PIM architecture. For example, a scheme to perform an operation (e.g., an integer operation vs. a floating-point operation), a scheme to arrange data (row-wise vs. column-wise), a scheme to access memory (sequential access vs. random access), and a method of storing an operation result (whether to reuse the operation result in the memory) may be important configuration variables. Additionally, the compatibility with an existing memory interface and an instruction set architecture (ISA) may be considered to effectively use the PIM operation.

Hereinafter, an example of a typical polynomial operation method is described.

A polynomial operation may play a core role in cryptography, signal processing, ML, and various mathematical operations. For example, a high-speed operation may be used in the field of homomorphic encryption, and technology to accelerate a polynomial operation in hardware may be used to effectively perform the high-speed operation.

The polynomial operation may be performed in a polynomial ring, which is a quotient ring for an irreducible polynomial Φ(x) as Equation 1 below, for example.

$${R}_{q} = {ℤ}_{q} [ X ] / Φ ( x ) \qquad Equation 1$$

The polynomial ring may be used for various problems that form the basis of contemporary cryptography, such as ring learning with errors (RLWE) and module learning with errors (MLWE). A cryptographic system based on this problem may be referred to as lattice cryptography. The most representative example may be a post-quantum cryptography standard.

The polynomial operation may be performed as follows.

When a degree of Φ(x) is N, an element of R_{q} may be a (N−1)-degree polynomial and have a form in which a coefficient of the polynomial is an element of [symbol] . In a computer, the element of [symbol] may be often represented as an integer within a range of [0, q−1]. The operations in R_{q} may perform modulo an N-degree polynomial, and since operations between coefficients are performed in [symbol] , a modular operation may be performed with modulus q.

An operation in the polynomial ring R_{q} may not be essential for an efficient operation, but a residue number system (RNS) may be used. The RNS may be used to efficiently process q, which is a modulus of R_{q}. Depending on the application, q may use a significantly great value, such as 2¹⁶⁰⁰, and performing a modulo operation on q having such a great value may be computationally expensive. To resolve this, q may be set to the product of L coprime integers, such as q=q₀q₁ . . . q_{L-1}, and the polynomial may be divided into multiple RNS pieces as Equations 2 and 3 below, for example. All vectors may be column vectors.

$$a ∈ {R}_{q} ↦ ( a [ 0 ] , a [ 1 ] , … , a [ L - 1 ] ) ∈ {R}_{{q}_{1}} \times {R}_{{q}_{2}} \times … \times {R}_{{q}_{L}} \qquad Equation 2$$

$$a [ i ] = a mod {q}_{i} ( i = 0 , 1 , … , L - 1 ) \qquad Equation 3$$

When the polynomial is divided as Equations 2 and 3, an operation may be performed between RNS pieces when performing an operation between polynomials. For example, addition may be performed as Equations 4 to 6 below, for example (subtraction may also be performed similarly).

$$a ∈ {R}_{q} ↦ ( a [ 0 ] , a [ 1 ] , … , a [ L - 1 ] ) ∈ {R}_{{q}_{0}} \times {R}_{{q}_{1}} \times … \times {R}_{{q}_{L - 1}} \qquad Equation 4$$

$$b ∈ {R}_{q} ↦ ( b [ 0 ] , b [ 1 ] , … , b [ L - 1 ] ) ∈ {R}_{{q}_{0}} \times {R}_{{q}_{1}} \times … \times {R}_{{q}_{L - 1}} \qquad Equation 5$$

$$a + b = ( a [ 0 ] + b [ 0 ] , a [ 1 ] + b [ 1 ] , … , a [ L - 1 ] + b [ L - 1 ] ) \qquad Equation 6$$

A coefficient of each RNS piece may exist in [symbol] , and thus, an operation between RNS pieces may be performed on a small integer within the range of [0, qᵢ−1], and this may be easily performed in the computer compared to performing an operation on q having a significantly great modulus.

As a result, when using the RNS, the polynomial may be formed of L RNS pieces, and each RNS piece may be the (N−1)-degree polynomial belonging to the polynomial ring R_{qi} that uses a smaller modulus qᵢ, and thus, one polynomial belonging to R_{q} may be regarded as a two-dimensional (2D) structure represented by L×N integer coefficients in the computer (rows correspond to respective RNS pieces). Accordingly, addition may be simply expressed by element-wise modulo addition between these 2D structures (however, each row uses a different modulus qᵢ).

When using the RNS, constant multiplication, which is another operation of the polynomial ring, may be simply performed by performing element-wise modulo multiplication on each element of the 2D structure.

Lastly, a multiplication operation between polynomials may be used (the ring is an algebraic structure in which addition and multiplication are defined). Similarly, multiplication between polynomials may be performed by multiplying between RNS pieces as Equation 7 below, for example.

$$a \cdot b = ( a [ 0 ] \cdot b [ 0 ] , a [ 1 ] \cdot b [ 1 ] , … , a [ L - 1 ] \cdot b [ L - 1 ] ) \qquad Equation 7$$

To efficiently perform multiplication between RNS pieces in the computer, Fourier transform types, such as number-theoretic transform (NTT), discrete Galois transform (DGT), and/or discrete Fourier transform (DFT), may be used.

Each RNS piece a[i], b[i] (i=0, 1, . . . , L−1) may be regarded as a coefficient vector of N, and Fourier transform [symbol] may be performed on each RNS piece. A result of multiplying RNS pieces may be obtained by performing element-wise multiplication (represented as ⊙) on results of performing Fourier transform and performing inverse Fourier transform [symbol] on the multiplication result. This may be represented by Equation 8 below, for example.

$$a [ i ] \cdot b [ i ] = {ℱ}^{- 1} ( ℱ ( a [ i ] ) ⊙ ℱ ( b [ i ] ) ) \qquad Equation 8$$

In this case, since operations, such as addition (subtraction), multiplication, and constant multiplication, may be performed multiple times while maintaining a state in which such Fourier transform is applied, the state in which Fourier transform is applied may be maintained without performing inverse Fourier transform.

In the described one or more embodiments, it is assumed that a state in which Fourier transform is applied to a polynomial is a default state, and based on that assumption, embodiments are described.

Fourier transform may have a different space to which a Fourier transform result belongs depending on their type, and the one or more embodiments are described based on NTT. However, the example is not limited thereto, and the description of the one or more embodiments may apply to a case in which a different Fourier transform is used.

A result of performing the NTT on each RNS piece may be represented as a vector of length N, as shown in Equation 9 below, for example.

$$ℱ ( {a}_{i} ) ∈ {ℤ}_{{q}_{i}}^{N} \qquad Equation 9$$

The entire polynomial to which NTT and the RNS are applied may be consequentially regarded a two-dimensional (2D) structure of size L×N. The polynomial addition (subtraction), multiplication, and constant multiplication may be performed by an element-wise modular operation in the 2D structure.

The memory device 100 in one or more embodiments may include one or more memory banks (e.g., the DRAM bank 110) and may include one or more operators (e.g., a PIM module 120) that are disposed to access the one or more memory banks and perform operations on the polynomial data. In an example, each of the PIM modules 120 may be a respective processor (e.g., a PIM processor and/or an in-memory processor). The memory device 100 may distribute data by distributing the polynomial data to one or more memory banks to enable parallel operations by one or more operators (e.g., one or more processors). The memory device 100 may perform a modular operation and store a modular operation result by controlling data input/output between one or more memory banks and one or more operators.

The following description describes the memory device 100 as DRAM as a representative example. However, the one or more embodiments are not limited to DRAM and may universally apply to the memory device 100 that may perform as PIM. Accordingly, the operation of the memory bank may be described by the operation of the DRAM bank 110.

Hereinafter, an example of an operating scheme of DRAM, which is the representative memory device 100, is described.

The DRAM bank 110 according to one or more embodiments may independently perform activation and precharge operations. In the memory device 100, while one DRAM bank 110 performs activation, the other DRAM bank 110 may read or write data.

The DRAM may have a hierarchical structure of channels, ranks, bank groups, and banks. Accordingly, the DRAM structure may be simplified into a structure that allows multiple DRAM banks 110 and the data in the DRAM bank 110 to be fetched to the outside of the DRAM via a shared global input/output (I/O) path. One DRAM bank 110 may include a DRAM cell array, a row decoder, a column decoder, a write driver, and an I/O sense amplifier (IOSA). The data in the DRAM bank 110 may be stored in the DRAM cell array, and abstractly, DRAM cells may be disposed in a 2D structure formed of multiple rows and columns, with each cell may retain 1-bit information.

The following process may be performed to obtain the data in the DRAM bank 110. i) Activation (ACT) may copy the data from a specific DRAM row to the IOSA (a power level of the IOSA is adjusted depending on the data). ii) Read/write (RD/WR) may read or write a chunk (e.g., a chunk of 256 bits) of some (e.g., one or more) consecutive data in the IOSA. iii) Precharge (PRE) may restore the power level of the IOSA to its original level as a preparation step to access the data in other DRAM rows.

In this case, the memory device 100 of one or more embodiments may minimize the costs of ACT and PRE by accessing multiple data chunks in the same DRAM row during the process of performing ACT and PRE. In addition, by independently performing this process by multiple DRAM banks 110, the memory device 100 of one or more embodiments may maximize the utilization of an I/O channel by multitasking of multiple DRAM banks 110, for example, performing data RD/WR in the DRAM bank 110 while performing ACT/PRE in the other DRAM bank 110.

Hereinafter, an example of a data distribution scheme between the DRAM banks 110 is described.

One or more DRAM banks 110 in one or more embodiments may be divided into a plurality of channels or groups. The DRAM may distribute polynomial coefficients (or polynomial data) to corresponding channels or groups.

The PIM may be performed by evenly distributing the data to the plurality of DRAM banks 110 and then performing operations in parallel on the data retained by each bank in the plurality of DRAM banks 110. Accordingly, the memory device 100 may distribute the data as evenly as possible.

As described above, one polynomial may be regarded as N×L 2D structure by applying the RNS thereto (RNS application is not mandatory, in this case, L=1), and each row of the 2D structure may process different modulus q₀, q₁, . . . , q_{L-1}.

The memory device 100 in one or more embodiments may distribute polynomial data for different modular operations to different memory dies (e.g., DRAM dies (e.g., bank groups 101 to 108 of FIG. 1)).

The memory device 100 may divide all DRAM dies in one computing system into PIM die groups having the same size and may designate a modulus processed by each PIM die group as evenly as possible.

For example, it is assumed that L=15 is satisfied and there is a GPU system provided with five high bandwidth memory (HBM) stacks (e.g., HBM stacks 100-1 to 100-5 of FIG. 1) (it is assumed that each HBM stack includes a structure in which eight DRAM dies are stacked). In this example, each HBM stack may be determined as a separate PIM die group. The first stack (the first PIM die group) may process q₀, q₅, q₁₀, the second stack (the second PIM die group) may process q₁, q₆, q₁₁, the third stack (the third PIM die group) may process q₂, q₇, q₁₂, the fourth stack (the fourth PIM die group) may process q₃, q₈, q₁₃, and the fifth stack (the fifth PIM die group) may process q₄, q₉, q₁₄.

In addition, when polynomial data is stored in the DRAM, the polynomial data may be evenly distributed according to the modulus processed by each PIM die group. When using the above example again, for a polynomial a, a[0], a[5], a[10], a[1], a[6], a[11], a[2], a[7], a[12], a[3], a[8], a[13], and a[4], a[9], a[14] may be distributed to the first stack, the second stack, the third stack, the fourth stack, and the fifth stack, respectively. Accordingly, each PIM die group may process the data by as much as N×(L/(# of PIM die groups)).

In each PIM die group, each row a[i] of the polynomial may be evenly distributed to all of the DRAM banks 110 in the PIM die group. In the above example, when it is assumed that each PIM die group includes eight DRAM dies, and 64 banks are in each DRAM die, the as much data as (N/512)×(L/(# of PIM die groups)) may be stored in each DRAM bank 110. This may be generalized into Equation 10 below, for example.

$$( N / ( \# of banks in a PIM die group ) ) \times ( L / ( \# of PIM die groups ) ) \qquad Equation 10$$

Hereinafter, an example of a parallel operation of distributed data is described.

One or more operators (e.g., the PIM modules 120) may be disposed inside the DRAM (the definition of inside may vary depending on the distance) adjacent (the degree of adjacency may vary depending on the implementation) to each DRAM bank 110 of the memory device 100.

Since the PIM uses a scheme in which one or more operators simultaneously fetch data from each DRAM bank 110 and compute and store the data, the PIM may obtain a higher level of bandwidth compared to a typical scheme in which a host processor fetches data from the outside of DRAM and computes and stores the data.

When the data is evenly distributed to the DRAM bank 110 as described above for the polynomial operation, an element-wise operation for the polynomial operation may be independently performed by each DRAM bank 110 in parallel.

A modular multiply-and-accumulator (MMAC) for performing a modulo operation for a polynomial element-wise operation may be disposed in each PIM module 120, and the operator may read the data from the adjacent DRAM bank 110, may compute the data, and may store the computed data in the DRAM bank 110.

An additional data path may be installed in the DRAM for this purpose. In this case, a data path for accessing the data in DRAM from the host processor may be maintained such that the host processor may fetch and use a PIM result.

Hereinafter, an example of an arrangement of operators in the memory device 100 is described.

The PIM module 120 (e.g., an operator) may be disposed in various manners depending on the type of DRAM device. For example, the PIM module 120 may be or include HBM-PIM, low power double data rate (LPDDR)-PIM, and/or universal processing memory (UPMEM)-PIM and may be disposed right next to the DRAM bank 110.

In another example, a DRAM device (e.g., one HBM stack) or a new chip for PIM in a unit of a module (e.g., a dual in-line memory module (DIMM)) may be added (e.g., an acceleration DIMM (AXDIMM) scheme) to a memory device, and/or logic circuitry for an operation may be added to the existing DRAM device/module controller chip.

As shown in FIG. 1, disposing the PIM module 120 right next to the DRAM bank 110 (or one for every several DRAM banks 110) may be referred to as near-bank PIM. The near-bank PIM may secure a high DRAM bandwidth proportional to the number of DRAM banks 110 connected to each DRAM channel.

For example, in the case of 8-Hi 16 GB HBM2E in which 16 banks are connected to each DRAM channel (pseudo-channel), when the PIM module 120 is disposed for each DRAM bank 110, 16 times the DRAM bandwidth may be used (however, it is assumed that overhead for an operation, such as DRAM ACT and PRE, is not considered).

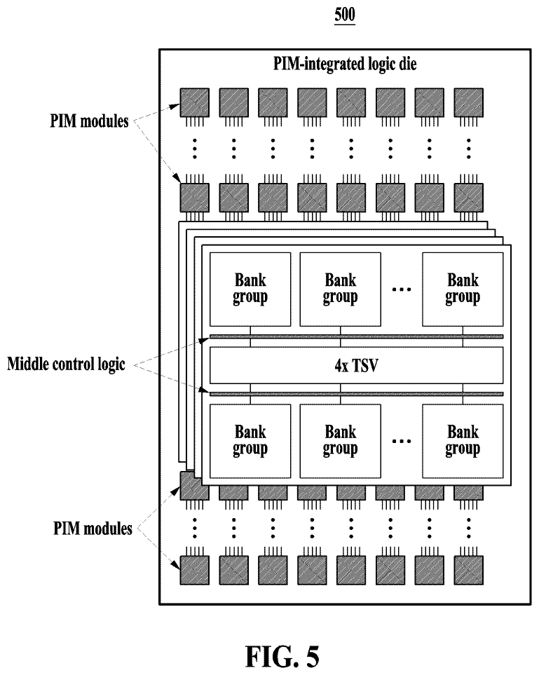

As shown in FIG. 5, disposing the PIM module 120 in a separate chip or a controller chip may be referred to as custom-logic PIM. Since custom-logic PIM may perform data communication over a short distance compared to the communication between the host processor and the DRAM, an enhanced bandwidth may be obtained by disposing an additional data path between the new custom-logic PIM module 120 and the DRAM bank 110.

In this case, the same PIM module 120 as used in the near-bank PIM may be employed. Additionally, multiple PIM modules 120 may be disposed such that each PIM module 120 is responsible for a portion of the DRAM banks 110 in the DRAM module or device. To support this, appropriate data paths may be added.

Referring to FIG. 1, the near-bank PIM in which the PIM module 120 is disposed may be identified, wherein the PIM module 120 is disposed near the DRAM bank 110 of the HBM and performs an operation by reading the data from an IOSA of the DRAM bank 110. Although FIG. 1 uses the HBM as an example, the example may apply to various DRAM devices, such as typical DDR DRAM, LPDDR DRAM, and GDDR.

Hereinafter, an example of a configuration of an operator in the memory device 100 is described.

One or more operators (e.g., one or more PIM modules 120) according to one or more embodiments may include a parallel operation path for performing at least one of modular addition, modular multiplication, and constant multiplication on a polynomial coefficient in parallel and may be configured to perform the operations in one or more operation cycles.

The one or more operators according to one or more embodiments may include a buffer 123 for storing an intermediate result and may store used data in the buffer 123 to reuse the stored data.

In the described one or more embodiments, a specialized operator (e.g., a MMAC 121) may be disposed in the PIM module 120 rather than a typical operator (e.g., a multiply-and-accumulator (MAC)) for PIM for a polynomial operation. Accordingly, multiple modular operators (e.g., the MMACs 121) may be disposed in each PIM module 120. In this case, a bit word size used for the modular operator may be determined by assuming the utilization of the RNS. Accordingly, the memory device 100 of one or more embodiments may improve the efficiency of the operator by reducing the word size.

One or more PIM modules 120 according to one or more embodiments may perform an operation corresponding to the bit-width (or the bit word size) of a polynomial coefficient and may perform a modular operation by using modulus information. The modulus information may correspond to a value of the modulus, precomputed data (e.g., additional precomputed data to use widely used modular reduction, such as Barrett reduction or Montgomery reduction) determined based on the modulus, and/or a result of reducing a constant by the modulus in the case of constant multiplication.

For example, a 28-bit word size may be set and multiple 28-bit modular operators specialized therefor may be disposed. In addition, when the NTT is used, the modulus, which is a prime number satisfying Equation 11 below, for example, may be used.

$${q}_{i} = 1 mod 2 N \qquad Equation 11$$

In the case of a specific modulus that satisfies Equation 11, a modular operator may be configured based on this condition, and the efficiency of the operator may be improved by circuit optimization.

Multiple modular operators may be disposed in each PIM module 120 to enable parallel operations. The number of operators may be determined based on a chunk module (e.g., 256 bits) used for reading/writing the data in the DRAM.

Referring to FIG. 1, in an example, it is assumed that eight pieces of 32-bit data are in a 256-bit chunk for the data usage by a general-purpose host processor, and eight modular operators are disposed. The PIM module 120 may read and write data in units of chunks from the IOSA and may perform a task on multiple data elements in a chunk in the same cycle by also performing an operation in units of chunks.

The eight modular operators may simultaneously perform operations in parallel by sharing values of the control, constant (constant of FIG. 1), and modulus (prime of FIG. 1). Each modular operator may be configured to perform one multiply-and-accumulate operation in each cycle.

One or more PIM modules 120 in one or more embodiments may process a compound operation through multiple modular multiplication and modular addition operations and may control a positive operation, a negative operation, and a constant multiplication operation in the compound operation process.

Each MMAC 121 may receive up to three 28-bit inputs and produce one 28-bit output. One of the inputs may be received from the IOSA of the adjacent DRAM bank 110 via a column select and a bank data interface, and the other two inputs may be received from a data buffer 123 used to store temporary data in the PIM module 120. When it is assumed that inputs are a, b, and c, one MMAC 121 may process an operation like Equation 12 below, for example. A broadcast constant value may be used instead of b and c.

$$( \pm a \times b \pm c ) mod {q}_{i} \qquad Equation 12$$

A value of a ± sign may be determined through a simple mux control signal, and various element-wise operations for the polynomial operation may be supported.

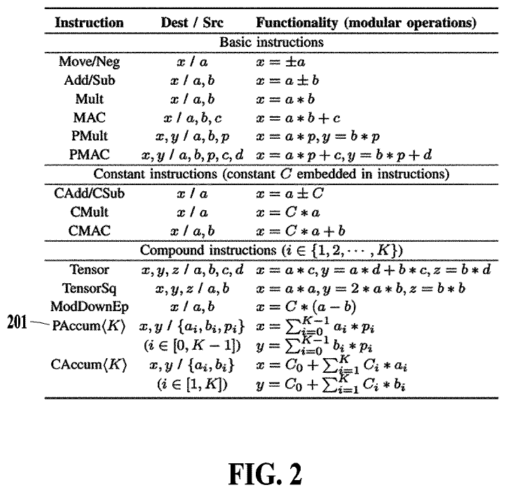

For example, referring to FIG. 2, various operations may be performed over multiple cycles. To perform a compound operation, a process of storing the data in the data buffer 123 in the middle, reading the data from the MMAC 121, and using the data in the MMAC 121. The data buffer 123 may have a structure to write one chunk and read two chunks in one cycle. To reduce the number of ports of the data buffer 123, a bypass route may exist in the MMAC 121, the bypass route may directly output the data received from the DRAM bank 110, and this output may be input to the data buffer 123. By the same port using the bypass route, the data from the DRAM bank 110 may be written to the data buffer 123 or a multiply-and-accumulate operation result may be written to the data buffer 123. It may be assumed that the data buffer 123 may store a total of B chunks (the number of (#) of data buffer 123 entries=B).

The overall control of the PIM module 120 may proceed by interpreting a PIM instruction from an instruction decoder in the PIM module 120 and transmitting a control signal to the MMAC 121 while transmitting a DRAM command to the DRAM bank 110 according to the interpreted signal.

Since a general DRAM operation is to be supported other than the PIM operation, the general DRAM command may be transmitted to the DRAM, and a general DRAM data output thereby may be transmitted to a separate data path via a bank data interface. The control signals may be transmitted to each PIM module 120 via a middle control logic adjacent to a through silicon via (TSV) at an appropriate timing.

Hereinafter, an example of modulus dependent additional data processing is described.

When the RNS is used, modulus information, which is additional data, may be used for a modular operation.

In the data distribution scheme described above, the same modulus may be processed by each PIM die group. Since the additional data is values determined by the modulus, the same value may be transmitted to the PIM die group. Accordingly, the additional data may be simply transmitted to the entire PIM module 120 belonging to each PIM group by distributing (broadcasting) the additional data to the mode PIM module 120 together with an operation control signal.

In the PIM module 120, the data buffer 123 for the modulus (prime in FIG. 1) and the constant (constant in FIG. 1) among the additional data may exist. The data may be distributed (e.g., broadcast) to each MMAC 121 from the buffer 123. Depending on the used modular reduction method, additional data therefor may be used in implementing the method, and in this case, the buffer 123 therefor may be added. However, in this example, optimization that eliminates the need for the additional data may be used by using the characteristics of a prime number. As described above, the modulus may be a prime number satisfying qᵢ=1 mod 2N. In this case, when using Montgomery reduction, additional data as Equation 13 below, for example, may be used for a word size W (W=28 since a 28-bit word is used in the example of FIG. 1).

$$- {q}_{i}^{- 1} mod {2}^{W} \qquad Equation 13$$

A degree N of a polynomial ring used for homomorphic encryption may satisfy N=2^{K}. In this case, if K≥W/2 is satisfied, Equation 14 below, for example, may be established.

$$- {q}_{i}^{- 1} = ( q - 2 ) mod {2}^{W} \qquad Equation 14$$

Accordingly, with the information about the modulus q; without the additional data, the additional data for Montgomery reduction may be obtained, and thus, the additional data may not be stored and may be used by computing the additional data.

Hereinafter, an example of a processing method of a compound operation (e.g., instruction) is described.

The memory device 100 according to one or more embodiments may generate one or more polygroups by mapping a polynomial coefficient in a 2D structure in each of the one or more DRAM banks 110.

An operator (e.g., the PIM module 120) according to one or more embodiments may perform a modular operation by accessing the one or more polygroups sequentially or in parallel when performing the operation.

The memory device 100 according to one or more embodiments may store a determined range of a polynomial coefficient in each row group by designating some or all of the one or more DRAM banks 110 to a plurality of row groups.

The memory device 100 according to one or more embodiments may distribute a determined range of a polynomial coefficient to each row group by designating some or all of memory cells in the DRAM bank 110 to a plurality of row groups.

The memory device 100 according to one or more embodiments may distribute a determined range of a polynomial coefficient to each column group by designating some or all of memory cells in the DRAM bank 110 to a plurality of column groups.

FIG. 2 is an example of an ISA of a polynomial computing device in a memory device, according to one or more embodiments.

Referring to FIG. 2, a relatively complex element-wise operation, such as PAccum<K> 201, may be identified. This compound operation may be used to reduce the number of reads/writes of the overall data. For example, PAccum<4> may perform operations such as Equations 15 and 16 below, for example.

$$Input : {a}_{0} , {b}_{0} , {p}_{0} , {a}_{1} , {b}_{1} , {p}_{1} , {a}_{2} , {b}_{2} , {p}_{2} , {a}_{3} , {b}_{3} , {p}_{3} \qquad Equation 15$$

$$Output : x = {a}_{0} \cdot {p}_{0} + {a}_{1} \cdot {p}_{1} + {a}_{2} \cdot {p}_{2} + {a}_{3} \cdot {p}_{3} , \qquad Equation 16$$

$$y = {b}_{0} \cdot {p}_{0} + {b}_{1} \cdot {p}_{1} + {b}_{2} \cdot {p}_{2} + {b}_{3} \cdot {p}_{3}$$

The reason for using the compound operation may be to eliminate a process of storing an intermediate result in the DRAM bank 110 as much as possible. For example, the operation may be performed by performing PMult first and repeating PMAC three times, and in this case, all four outputs x, y including the intermediate result may be stored in the DRAM bank 110. On the other hand, when using PAccum<4>, x, y may be stored in the DRAM bank 110 only once.

However, when performing the compound operation, a lot of ACT/PRE overhead may be required to access the data in the DRAM bank 110. For example, when each one element of 12 input polynomials of PAccum<4> is to be alternately read and the data of each polynomial is in all different DRAM rows, ACT/PRE may be performed once on each element. This may consume a lot of time to perform ACT/PRE compared to the actual time to RD/WR.

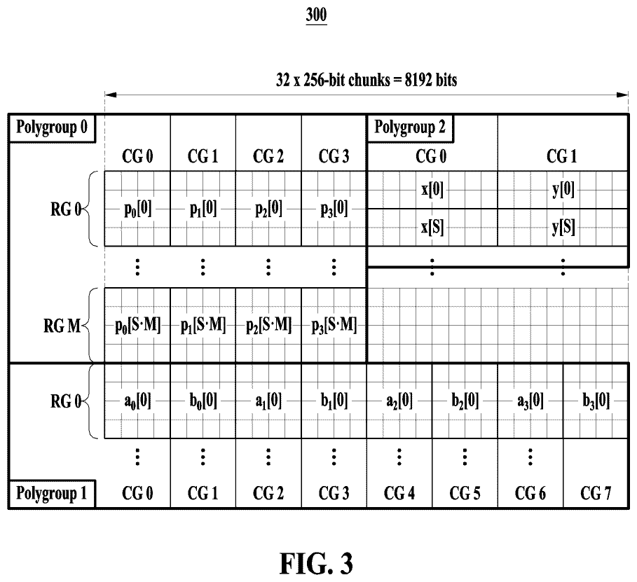

To resolve this problem, the memory device 100 of one or more embodiments may use a column partitioning data layout 300 of FIG. 3 for arranging multiple polynomials in a single DRAM row in response to a programmer's request.

FIG. 3 is a schematic diagram of a column partitioning data layout according to one or more embodiments.

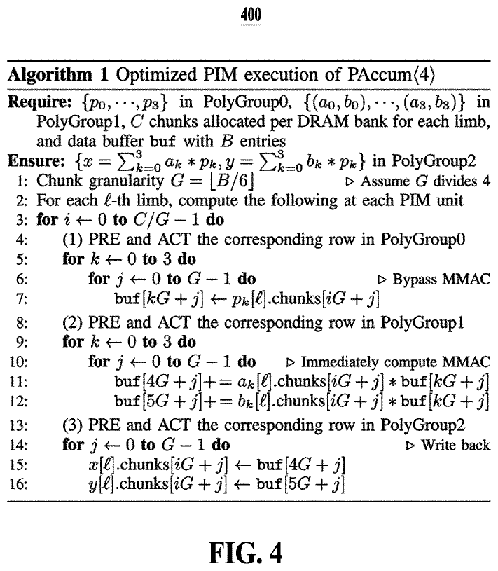

FIG. 4 is a diagram of an operation performing algorithm of PAccum, according to one or more embodiments.

Referring to FIGS. 3 and 4, an example of the column partitioning data layout 300 and a method of performing PAccum<4> by using the column partitioning data layout 300 may be identified.

In FIG. 3, when there are S PIM die groups, (M+1) moduli may be assigned to the first PIM die group. In addition, since the number of columns of the DRAM bank 110 is 8192 bits and the module of the data chunk is 256 bits (8 elements when it is assumed that one element is stored in 32 bits), 32 chunks (#_{chunk}=32) may exist in each DRAM row.

In addition, since (N/(# of banks in a PIM die group))=128 is satisfied, an RNS piece of each polynomial may be distributed to assign 128 elements (16 chunks) to each DRAM bank 110 in one PIM die group.

In this case, the data allocation may be performed as follows.
i) DRAM rows may be divided into #_{CG} (e.g., 4, 8, or 16) column groups (CG) at runtime. Each column group may be formed of #_{chunk}/#_{CG} (e.g., 8, 4, or 2) chunks.
ii) C chunks (e.g., C=16) of each RNS piece allocated to one DRAM bank 110 may be sequentially stored across multiple (e.g., 2, 4, or 8) DRAM rows in one column group. The sequential DRAM rows storing one RNS piece may form a row group (RG).
iii) A programmer may receive a data structure indicated the polygroup formed of multiple row groups and multiple column groups in response to the request for related data (e.g., FIG. 3 provides an example including adjacent column groups and row groups, but the example is not limited thereto).

When storing multiple polynomials in the polygroup, different polynomials may be stored in different column groups, and an RNS piece corresponding to a different modulus may be stored in a different row group.

In other words, one polynomial may be arranged in one column group, and an RNS piece corresponding to the same modulus of different polynomials may be arranged in one row group.

By arranging the data as described above, RNS pieces corresponding to the same modulus of different polynomials may be arranged in the same DRAM row position, and thus, the memory device 100 of one or more embodiments may obtain multiple elements without additional PRE/ACT when alternately accessing data of multiple polynomials.

For example, when performing PAccum<4>, the number of PRE/ACT operations may be reduced by performing the operation as shown in Algorithm 1 400 of FIG. 4. Algorithm 1 400 may determine a value called chunk granularity G first, and the value may indicate the number of chunks of data on which the element-wise operation is performed at a time for each polynomial. The value of G may be determined depending on the size (B entries for chunks) of the data buffer 123 included in the PIM module 120 and the type of operations. In the case of the PAccum<4> operation, G=floor(B/6) may be determined.

For example, based on the assumption that B=16 and G=2, the operations may be performed in the following order.
i) To p₀, p₁, p₂, p₃ polynomials in polygroup 0, G chunks may be fetched from the IOSA and may be stored in the data buffer 123. In this case, it may be ensured that the 4G chunks are in the same DRAM row by the column partitioning data layout 300, and during this process, PRE/ACT may be performed once.
ii) While fetching G chunks of a₀, a₁, a₂, a₃, b₀, b₁, b₂, b₃ polynomials in polygroup 1 from the IOSA, x=a₀·p₀+a₁·p₁+a₂·p₂+a₃·p₃, y=b₀·p₀+b₁·p₁+b₂·p₂+b₃·p₃ may be computed over multiple cycles by using p₀, p₁, p₂, p₃ values stored in the buffer 123. Intermediate computation results of x, y may be stored in the data buffer 123. During this process, PRE/ACT may be performed once similar to i).
iii) A final computation result may be stored in x, y in polygroup 2. Similarly, PRE/ACT may be performed once.

Since processes i), ii), and iii) are to be performed on C chunks (e.g., C=16), the processes may be repeated a total of C/G times, and by iteratively performing the processes on all RNS pieces retained by the DRAM bank 110, the process of PAccum<4> may be completed.

When the column partitioning data layout 300 is not used and each polynomial is stored in a different DRAM row (e.g., in the case of typical sequential data storage), PRE/ACT may be used 4 times as much as i), 8 times as much as ii), and twice as much as iii).

FIG. 5 is a schematic diagram of custom-logic PIM, according to one or more embodiments.

The description provided with reference to FIGS. 1 to 4 may apply to the example of FIG. 5, and a repeated description may be omitted.

The PIM device and operating method of the one or more embodiments that describes an example in which near-bank PIM is used for the HBM may be applied to other PIM structures.

For example, the example may be applied to a custom-logic PIM 500 in addition to the case in which near-bank PIM is used for the structure, such as LPDDR, DDR, and GDDR.

Referring to FIG. 5, a structure in which the custom-logic PIM 500 is applied to the HBM may be identified. There may be a logic die that performs tasks, such as controlling DRAM dies under multiple DRAM dies, collecting data from the DRAM die, and transmitting the collected data to a host processor, and the HBM may implement the custom-logic PIM 500 by disposing the PIM modules 120 on the logic die and connecting the PIM modules 120 to some DRAM banks 110 on the DRAM dies. This scheme may maintain the bandwidth between the logic die and the host processor, but a higher bandwidth may be required between the logic die and the DRAM die. For the HBM, this may be implemented by disposing more TSVs for PIM.

For example, FIG. 5 shows a structure for performing PIM operation by increasing the bandwidth between the logic die and the DRAM dies by four times by disposing four times as many data TSVs as existing TSVs (since there are TSVs for transmitting power, it is sufficient to increase TSVs for data by four times rather than increasing the number of all TSVs by four times), disposing PIM modules on the logic die per (# of DRAM banks 110 in a pseudochannel)/4=4 DRAM banks 110, respectively, and connecting four DRAM banks 110 belonging to the same pseudochannel via the TSVs added to the PIM module 120. Similarly, eight times of TSVs may be disposed and one PIM module 120 may be disposed per two DRAM banks 110, and 16 times/one, twice/eight may be possible.

Although the implementation of PIM may vary, the existing data distribution methodology and optimization method may be identically applied except for disposing one PIM module 120 per multiple DRAM banks 110. When one PIM module 120 is disposed per multiple DRAM banks 110, similar to the typical DRAM operation, by using the fact that one PIM module 120 performs a task with multiple DRAM banks 110, while adjusting the timing of a DRAM command and performing PRE/ACT by one DRAM bank 110, time overhead of PRE/ACT may be partially hidden by fetching data prepared by the other DRAM bank 110 from the IOSA.

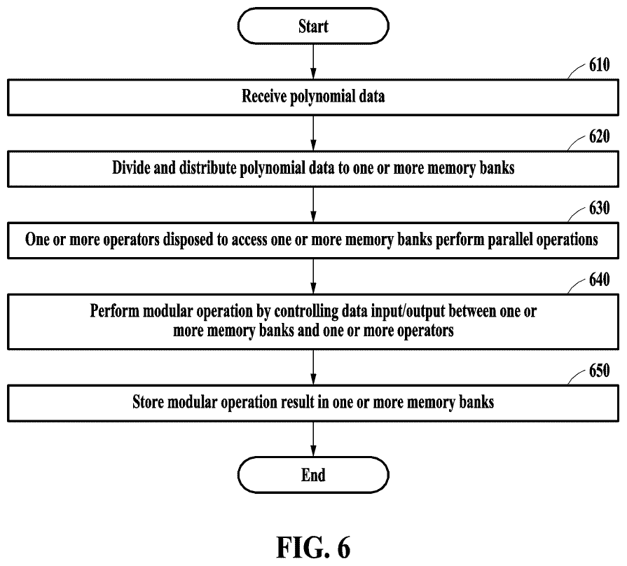

FIG. 6 is a schematic flowchart of an operating method of a memory device, according to one or more embodiments.

The description provided with reference to FIGS. 1 to 5 may apply to the example of FIG. 6, and a repeated description may be omitted.

For ease of description, operations 610 to 640 are described as being performed using the memory device 100 shown in FIG. 1. However, operations 610 to 640 may be used through any other appropriate electronic device and in any other appropriate system.

Furthermore, operations 610 to 650 of FIG. 6 may be performed in the sequence and manner as illustrated in FIG. 6. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 610, the memory device 100 may receive polynomial data.

In operation 620, the memory device 100 may divide and distribute the polynomial data to one or more memory banks.

The memory device 100 according to one or more embodiments may divide the one or more memory banks into a plurality of channels or groups. The memory device 100 may distribute the data such that polynomial coefficients are distributed to the divided channels or groups.

The memory device 100 according to one or more embodiments may distribute the polynomial data for different modular operations to another memory die to distinguish the polynomial data by modulus.

The memory device 100 according to one or more embodiments may generate one or more polygroups by mapping the polygroups coefficients into a 2D structure in each of the one or more memory banks.

The memory device 100 according to one or more embodiments may designate some or all of memory cells in the memory bank to a plurality of row groups. The memory device 100 may distribute a determined range of the polynomial coefficients to each row group.

The memory device 100 according to one or more embodiments may designate some or all of memory cells in the memory bank to a plurality of column groups. The memory device 100 may distribute a determined range of the polynomial coefficients to each column group.

The memory device 100 according to one or more embodiments may process a compound operation through a plurality of modular multiplication and modular addition operations and may control a positive operation, a negative operation, and a constant multiplication operation during the compound operation process.

In operation 630, in the memory device 100, one or more operators disposed to access the one or more memory banks may perform a parallel operation.

In operation 640, the memory device 100 may perform a modular operation by controlling data I/O between the one or more memory banks and the one or more operators.

The memory device 100 according to one or more embodiments may perform the modular operation by accessing one or more polygroups sequentially or in parallel when performing the operation.

The memory device 100 according to one or more embodiments may perform at least one of modular addition, modular multiplication, and constant multiplication operations on the polynomial coefficient in parallel. The memory device 100 may perform the operations in one or more operation cycles.

The memory device 100 according to one or more embodiments may include the buffer 123 to store an intermediate result.

The memory device 100 according to one or more embodiments may perform an operation corresponding to the bit-width of the polynomial coefficient and may perform the modular operation by using modulus information.

In operation 650, the memory device 100 may store the modular operation result in one or more memory banks.

The memory device 100 according to one or more embodiments may independently perform activation and precharge operations, and while one memory bank performs activation, the other memory bank may read or write the data from or to a preactivated row.

The electronic devices, one or more memory devices, HBM stacks, DRAM banks, PIM modules, MMACs, buffers, custom-logic PIMs, electronic device 10, one or more memory devices 100, HBM stacks 100-1 to 100-5, DRAM bank 110, PIM module 120, MMAC 121, buffer 123, and custom-logic PIM 500 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A memory device comprising:
one or more memory banks; and
one or more operators disposed to access the one or more memory banks and configured to perform an operation on polynomial data,
wherein, in response to the polynomial data being distributed to the one or more memory banks, the one or more operators are configured to perform parallel operations on the polynomial data, and
in response to controlling data input/output between the one or more memory banks and the one or more operators, the one or more operators are configured to perform a modular operation and the one or more memory banks are configured to store a result of the modular operation.

2. The memory device of claim 1, wherein
the one or more memory banks are divided into a plurality of channels or groups, and
polynomial coefficients of the polynomial data are distributed to a corresponding channel or group.

3. The memory device of claim 1, wherein pieces of the polynomial data for different modular operations are distributed to different memory dies.

4. The memory device of claim 1, wherein one or more polygroups are generated by mapping polynomial coefficients of the polynomial data into a two-dimensional (2D) structure in each of the one or more memory banks.

5. The memory device of claim 4, wherein, for the performing of the modular operation, the one or more operators are configured to perform the modular operation on the polynomial data by accessing the one or more polygroups sequentially or in parallel.

6. The memory device of claim 4, wherein a determined range of a polynomial coefficient is distributed to each row group by designating one or more memory cells in the memory bank to a plurality of row groups.

7. The memory device of claim 4, wherein a determined range of a polynomial coefficient is distributed to each column group by designating one or more memory cells in the memory bank to a plurality of column groups.

8. The memory device of claim 1, wherein
the one or more operators comprise a parallel operation path for performing any one or any combination of any two or more of modular addition, modular multiplication, and constant multiplication operations on a polynomial coefficient in parallel, and
the one or more operators are configured to perform the any one or any combination of any two or more of the modular addition, the modular multiplication, and the constant multiplication operations in one or more operation cycles.

9. The memory device of claim 1, wherein
the one or more operators comprise a buffer for storing an intermediate result, and
the one or more operators are configured to store used data in the buffer and reuse the used data.

10. The memory device of claim 1, wherein the one or more operators are configured to:
perform an operation corresponding to a bit-width of a polynomial coefficient of the polynomial data; and
perform the modular operation by using modulus information.

11. The memory device of claim 1, wherein the one or more operators are configured to:
process a compound operation through a plurality of modular multiplication operations and a plurality of modular addition operations; and
control a positive operation, a negative operation, and a constant multiplication operation during a process of the compound operation.

12. The memory device of claim 1, wherein
the one or more memory banks are configured to independently perform activation and precharge operations, and
while one of the one or more memory banks performs activation, another one of the one or more memory banks is configured to read or write data from or to a preactivated row.

13. An electronic device comprising:
one or more host processors; and
the memory device of claim 1,
wherein a polynomial operation command and the polynomial data are received by the one or more memory devices from the one or more host processors and are provided to the one or more operators.

14. A method of operating a memory device, the method comprising:
dividing and distributing polynomial data to one or more memory banks;
performing a parallel operation by one or more operators disposed to access the one or more memory banks;
performing a modular operation by controlling data input/output between the one or more memory banks and the one or more operators; and
storing a result of the modular operation in the one or more memory banks.

15. The method of claim 14, wherein the dividing and distributing of the polynomial data to one or more memory banks comprises:
dividing the one or more memory banks into a plurality of channels or groups; and
distributing the polynomial data to distribute polynomial coefficients of the polynomial data to the divided channels or groups.

16. The method of claim 14, wherein the dividing and distributing of the polynomial data to one or more memory banks comprises distributing polynomial data for different modular operations to different memory dies to distinguish the polynomial data by modulus.

17. The method of claim 14, wherein the dividing and distributing of the polynomial data to one or more memory banks further comprises generating one or more polygroups by mapping polynomial coefficients of the polynomial data into a two-dimensional (2D) structure in each of the one or more memory banks.

18. The method of claim 17, wherein the performing of the modular operation comprises performing the modular operation by accessing the one or more polygroups sequentially or in parallel.

19. The method of claim 17, wherein the generating of the one or more polygroups comprises:
designating one or more memory cells in the memory bank to a plurality of row groups; and
distributing a determined range of a polynomial coefficient of the polynomial data to each of the row groups.

20. An electronic device comprising:
one or more host processors; and
one or more memory devices, each comprising:
one or more memory banks; and
one or more operators disposed to access the one or more memory banks and configured to perform an operation on polynomial data,
wherein a polynomial operation command and polynomial data received by the one or more memory devices from the one or more host processors are provided to the one or more operators,
the polynomial data is divided into channels or groups and the divided polynomial data is distributed to the one or more memory banks,
a modular operation is performed by the one or more operators by reading the polynomial data from the one or more memory banks, and
a result of the modular operation is stored in the one or more memory banks.
